(19) United States
(12) Patent Application Publication
(10) Pub. No.: US 2026/0307227 A1
(43) Pub. Date: Oct. 8, 2026

(54) POWERED FASTENER DRIVER

(71) Applicant: TECHTRONIC CORDLESS GP, Anderson, SC (US)

(72) Inventors: Garrett C. Gerdes, Greenville, SC (US); Scott A. Sutherland, Greenville, SC (US)

(21) Appl. No.: 19/634,603

(22) Filed: Mar. 31, 2026

Related U.S. Application Data
(60) Provisional application No. 63/782,378, filed on Apr. 2, 2025.

(51) Int. Cl. B25C 1/04; B25C 5/13; B25C 1/06

(52) U.S. Cl. CPC B25C 1/047; B25C 5/13; B25C 1/06

(57) ABSTRACT

A powered fastener driver includes a housing containing a cylinder with a piston that moves between a top-dead-center (TDC) position and a bottom-dead-center (BDC) position. Attached to the piston, a driver blade travels along a driving axis to drive fasteners, and has lifter teeth on one side and latch teeth on the other. A lifter engages the lifter teeth to raise the piston and blade, powered by a drive unit. The latch shifts between released and latched positions. When released, the latch does not contact the latch teeth; when latched, it engages the latch teeth to block blade movement of the driver blade from the TDC position to the BDC position. The latch transitions between these positions based on direct contact with specific latch teeth during the blade’s movement toward the TDC position or the BDC position.

### CROSS-REFERENCE TO RELATED APPLICATIONS

This application claims priority to U.S. Provisional Patent Application No. 63/782,378 filed on Apr. 2, 2025, the entire content of which is incorporated herein by reference.

### FIELD OF THE INVENTION

The present invention relates to power tools, and more particularly to powered fastener drivers.

### BACKGROUND OF THE INVENTION

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.), but often these designs are met with power, size, and cost constraints.

### SUMMARY OF THE INVENTION

In some aspects, the techniques described herein relate to a powered fastener driver including: a housing; a cylinder within the housing; a piston movable within the cylinder from a top-dead-center (TDC) position to a driven or bottom-dead-center (BDC) position; a driver blade attached to the piston for movement therewith along a driving axis from the TDC position toward the BDC position for driving a fastener into a workpiece, the driver blade including a first longitudinal side having a plurality of lifter teeth, and a second longitudinal side having a plurality of latch teeth; a lifter operable to engage the plurality of lifter teeth and move the piston and driver blade from the BDC position toward the TDC position; a drive unit operably coupled to the lifter to provide torque thereto, causing the lifter to rotate; and a latch movable between a released position in which the latch is incapable of contacting any of the latch teeth, and a latched position in which the latch directly contacts the latch teeth to prevent movement of the driver blade from the TDC position toward the BDC position, wherein the latch is moved from the latched position to the released position in response to direct contact with a first latch tooth of the plurality of latch teeth during movement of the driver blade toward the TDC position, and wherein the latch is moved from the released position to the latched position in response to direct contact with a second latch tooth of the plurality of latch teeth during movement of the driver blade toward the BDC position.

In some aspects, the techniques described herein relate to a powered fastener driver including: a cylinder; a piston movable within the cylinder from a top-dead-center (TDC) position to a driven or bottom-dead-center (BDC) position; a driver blade attached to the piston for movement therewith along a driving axis from the TDC position toward the BDC position for driving a fastener into a workpiece, the driver blade including a plurality of lifter teeth, and a plurality of latch teeth separate from the lifter teeth; a lifter operable to engage the plurality of lifter teeth and move the piston and driver blade from the BDC position toward the TDC position; a latch pivotable between a released position in which the latch is incapable of contacting any of the latch teeth, and a latched position in which the latch directly contacts the latch teeth to prevent movement of the driver blade from the TDC position toward the BDC position; and a detent mechanism including a pin configured to engage and maintain the latch in the released position after the latch is pivoted to the released position, and a spring biasing the pin outward from a bore in which the pin is received to a position where the pin is engageable by the latch, wherein the pin maintains the latch in the released position until overridden by contact with the driver blade to return the latch to the latched position.

In some aspects, the techniques described herein relate to a latch system for selectively retaining a driver blade in a powered fastener driver, the latch system including: a latch movable between a latched position and a released position; a plurality of latch teeth on the driver blade, including at least a first latch tooth and a second latch tooth spaced along a longitudinal side of the driver blade; a first finger on the latch configured to engage one of the plurality latch teeth to hold the driver blade in an intermediate position between a bottom-dead-center (BDC) position and a top-dead-center (TDC) position; a second finger on the latch configured to be contacted by the first latch tooth during movement of the driver blade toward the TDC position to move the latch from the latched position to the released position; and a detent mechanism configured to maintain the latch in the released position until overridden by movement of the driver blade toward the BDC position.

### BRIEF DESCRIPTION OF DRAWINGS

FIG. 1 is a bottom perspective view of a powered fastener driver in accordance with an embodiment of the invention.

FIG. 2 is a bottom view of the powered fastener driver of FIG. 1.

FIG. 3 is a side view of the powered fastener driver of FIG. 1.

FIG. 4 is a side cross-sectional view of the powered fastener driver of FIG. 3, illustrating a frame and a nosepiece.

FIG. 5 is an opposite side view of the powered fastener driver of FIG. 1, with portions of a housing removed for clarity and illustrating a motor, transmission, and lifter assembly.

FIG. 6 is a perspective view of the nosepiece of FIG. 4, illustrating the nosepiece maintained in a closed position by a nosepiece latch.

FIG. 7 is a perspective view of a driver blade and lifter assembly of the powered fastener driver of FIG. 1.

FIGS. 8-11, in sequence, are cross-sectional views of the powered fastener driver of FIG. 1, illustrating the lifter assembly returning a driver blade from a bottom dead center position toward a top dead center position, with a driver blade latch in a released position until being moved to a latched position in FIG. 11.

FIGS. 12-13, in sequence, are cross-sectional views of the driver blade after being released from the lifter assembly, moving toward the bottom dead center position, with the driver blade latch in the released position.

FIG. 14 is a cross-sectional view of a detent mechanism for holding the driver blade latch in the released position.

FIGS. 15-19, in sequence, are cross-sectional views of the driver blade being returned toward the top dead center position after a fastener jam.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

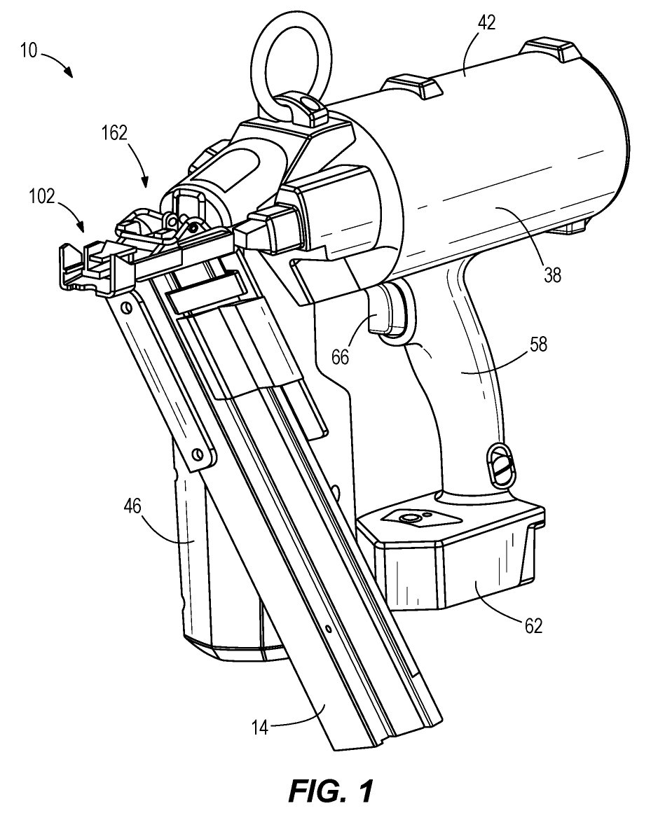

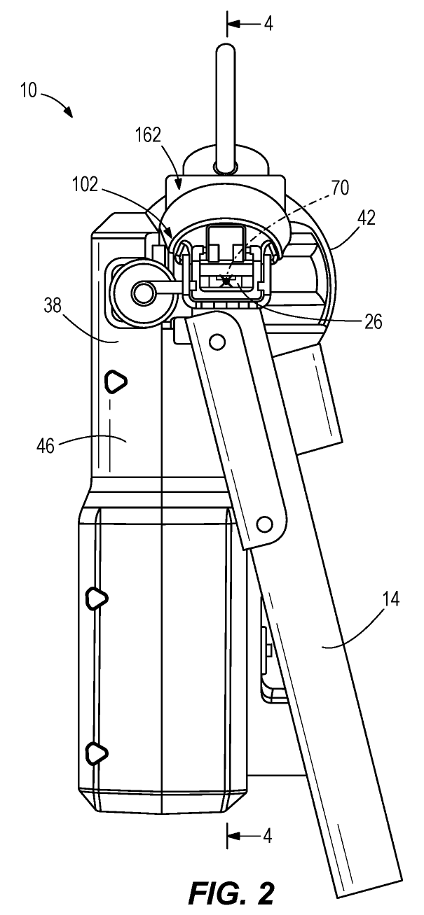

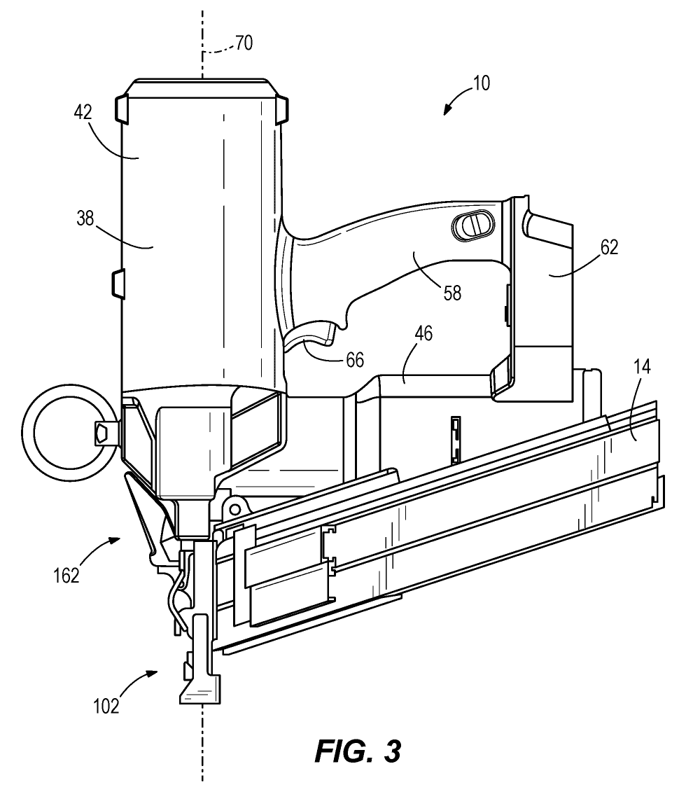

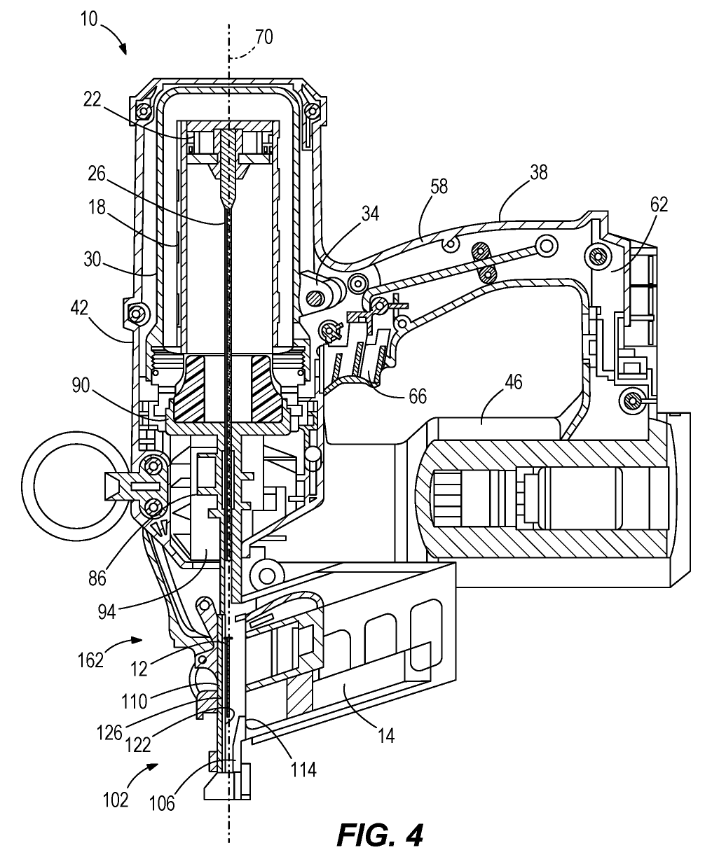

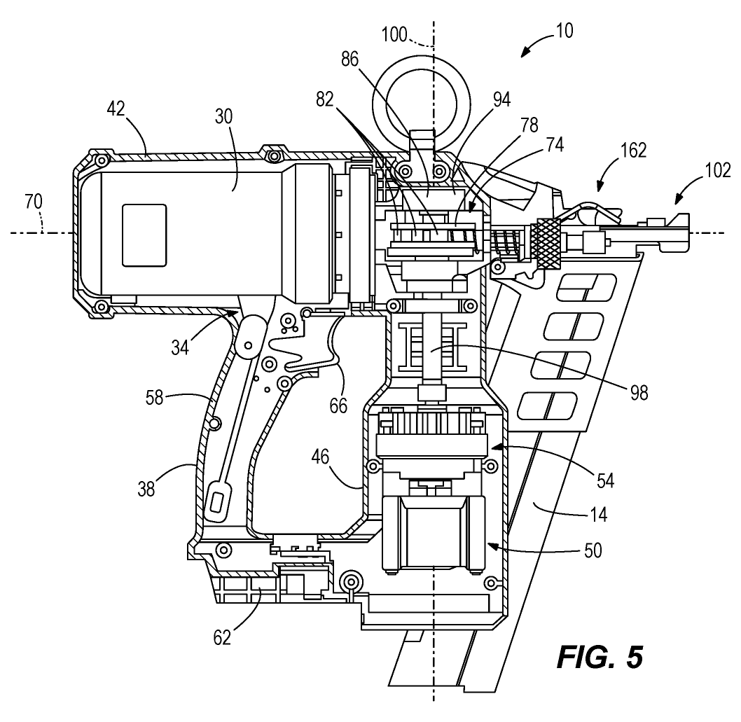

With reference to FIGS. 1-5, a powered fastener driver 10 is operable to drive fasteners 12 (e.g., staples, tacks, nails, etc.) held within a magazine 14 into a workpiece. In the illustrated embodiment, the powered fastener driver 10 is a gas spring stapler operable to drive staples. The fastener driver 10 includes an inner cylinder 18 and a moveable piston 22 positioned within the cylinder 18 (FIG. 4). The fastener driver 10 further includes a driver blade 26 that is attached to the piston 22 and moveable therewith. The fastener driver 10 does not require an external source of air pressure, but rather includes an outer storage chamber cylinder 30 of pressurized gas in fluid communication with the inner cylinder 18. In the illustrated embodiment, the inner cylinder 18 and moveable piston 22 are positioned within the storage chamber cylinder 30. With reference to FIG. 5, the driver 10 further includes a fill valve assembly 34 coupled to the storage chamber cylinder 30. When connected with a source of compressed gas, the fill valve assembly 34 permits the storage chamber cylinder 30 to be refilled with compressed gas if any prior leakage has occurred. The fill valve assembly 34 may be configured as a Schrader valve, for example.

With continued reference to FIG. 5, the fastener driver 10 includes a housing 38 having a cylinder housing portion 42 and a motor housing portion 46 extending therefrom. The cylinder housing portion 42 is configured to support the cylinders 18, 30, whereas the motor housing portion 46 is configured to support a motor 50 and a transmission 54 operatively coupled to the motor 50. The housing 38 further includes a handle portion 58 extending from the cylinder housing portion 42, and a battery attachment portion 62 coupled to an opposite end of the handle portion 58. A battery pack (not shown) is electrically connectable to the motor 50 for supplying electrical power to the motor 50. The handle portion 58 supports a trigger 66, which is depressed by a user to initiate a firing cycle of the fastener driver 10.

With reference to FIGS. 4 and 5, the inner cylinder 18 and the driver blade 26 define a driving axis 70. During a driving cycle, the driver blade 26 and piston 22 are moveable between a top-dead-center (TDC) (i.e., retracted) position and a driven or bottom-dead-center (BDC) (i.e., extended) position. The fastener driver 10 further includes a lifting assembly 74 (FIG. 5), which is driven by the motor 50, and which is operable to move the driver blade 26 from the BDC position to the TDC position.

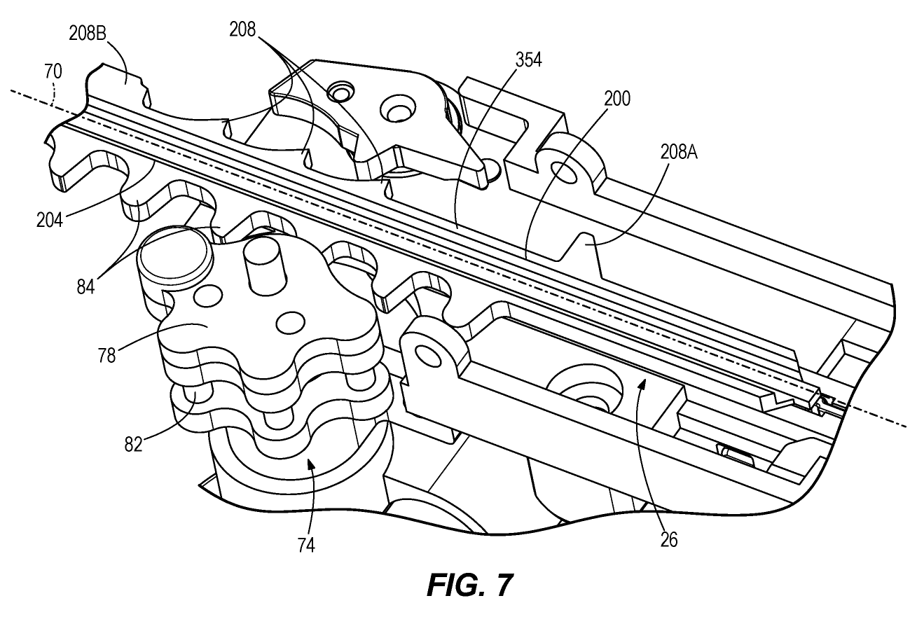

In operation, the lifting assembly 74 drives the piston 22 and the driver blade 26 toward the TDC position by energizing the motor 50. In particular, the lifting assembly 74 includes a lifter 78 having drive pins 82 that are sequentially engageable with teeth 84 (FIG. 7) on one side of the driver blade 26 to raise the driver blade 26 from the BDC position toward the TDC position. As the piston 22 and the driver blade 26 are driven toward the TDC position, the gas above the piston 22 and the gas within the storage chamber cylinder 30 is compressed. Prior to reaching the TDC position, the motor 50 is deactivated and the piston 22 and the driver blade 26 are held in a ready position, which is located between the TDC and the BDC positions, until initiation of a subsequent fastener driving cycle by user activation of the trigger 66. When the driver blade 26 is released by the lifter 78, the compressed gas above the piston 22 and within the storage chamber cylinder 30 drives the piston 22 and the driver blade 26 toward the BDC position, thereby driving a fastener into the workpiece. The illustrated fastener driver 10 therefore operates on a gas spring principle utilizing the lifting assembly 74 and the piston 22 to further compress the gas within the inner cylinder 18 and the storage chamber cylinder 30. Further detail regarding the structure and operation of the fastener driver 10 is provided below.

With continued reference to FIGS. 4 and 5, the driver 10 further includes a frame 86 positioned within the housing 38. The frame 86 includes a cylinder support portion 90 and a lifter housing portion 94. The cylinder support portion 90 is coupled to the lower end of the inner cylinder 18 (FIG. 4). In the illustrated embodiment, the cylinder support portion 90 is threaded to an inner surface of the inner cylinder 18. The lifter housing portion 94 supports the lifting assembly 74 (FIG. 5).

With reference to FIG. 5, the transmission 54 includes an output shaft 98 extending to the lifter 78 of the lifting assembly 74. The transmission 54, which is driven by the motor 50, provides torque to the lifter 78, causing it to rotate. The transmission 54 may be configured as a planetary transmission having a one or more planetary stages. The output shaft 98 defines a rotational axis 100 about which the lifter 78 rotates.

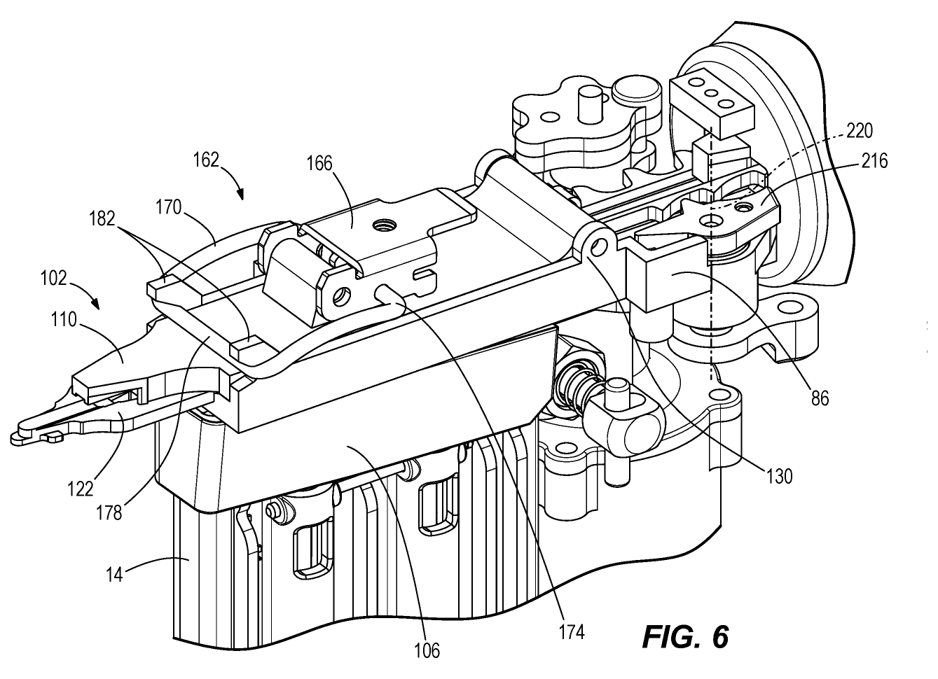

With reference to FIGS. 4 and 6, the driver 10 further includes a nosepiece 102 supported by the frame 86. The nosepiece 102 includes a nosepiece base 106 and a nosepiece cover 110 movably coupled to the nosepiece base 106. In the illustrated embodiment, the nosepiece base 106 is separate and affixed to the frame 86. In other embodiments the nosepiece base 106 is integral with the frame 86. The nosepiece base 106 is positioned at a front end 114 (FIG. 4) of the magazine 14. The nosepiece cover 110 substantially covers the nosepiece base 106 (FIG. 6). In the illustrated embodiment, the nosepiece cover 110 is releasably coupled to the nosepiece base 106 by a nosepiece latch 162.

The nosepiece base 106 and the nosepiece cover 110 form a firing channel 122 therebetween (FIG. 4). The magazine 14 includes a fastener channel 126 along a length thereof. The firing channel 122 is in communication with the fastener channel 126. The firing channel 122 is configured to consecutively receive the fasteners from a fastener strip stored in the fastener channel 126 of the magazine 14. The firing channel 122 is aligned with the driving axis 70 of the driver blade 26.

With reference to FIG. 6, the nosepiece cover 110 is pivotably coupled to the nosepiece base 106 by a pivot joint 130. If a fastener 12 becomes jammed within the firing channel 122, the nosepiece cover 110 can be pivoted to an open position to clear the jam. The nosepiece cover 110 is secured in a closed position by the latch 162. The latch 162 includes a lever 166 that is pivotable about the nosepiece cover 110 and is configured to be grasped by a user. The latch 162 further includes a spring 170 having a first end 174 connected to the lever 166 and a second end 178 opposite the first end 174. The second end 178 of the spring 170 is received within hooks 182 formed on the nosepiece base 106 for securing the nosepiece cover 110 to the nosepiece base 106, thereby positioning the latch 162 in a latched state (FIG. 6). The latch 162 is movable from the latched state to a released state, in which the spring 170 is disengaged from the hooks 182 and the nosepiece cover 110 is pivotable away from the nosepiece base 106.

With reference to FIG. 7 the driver blade 26 includes a body 200. The driver blade 26 further includes lifter teeth 84 positioned along the length of the body 200. The lifter teeth 84 extend from a first side 204 of the body 200 of the driver blade 26 in a non-perpendicular direction relative to the driving axis 70. The drive pins 82 (or roller bushings positioned on each of the drive pins 82) of the lifter 78 are engageable with the teeth 84 for returning the driver blade 26 from the BDC position toward the TDC position. The driver blade 26 further includes axially spaced latch teeth 208 formed on a second side 354 of the body 200 of the driver blade 26 opposite the lifter teeth 84. A lowermost or first latch tooth 208A is spaced closer to a distal end of the nosepiece 102 from which the fasters are discharged and an uppermost or second latch tooth 208B is spaced further from the distal end of the nosepiece 102.

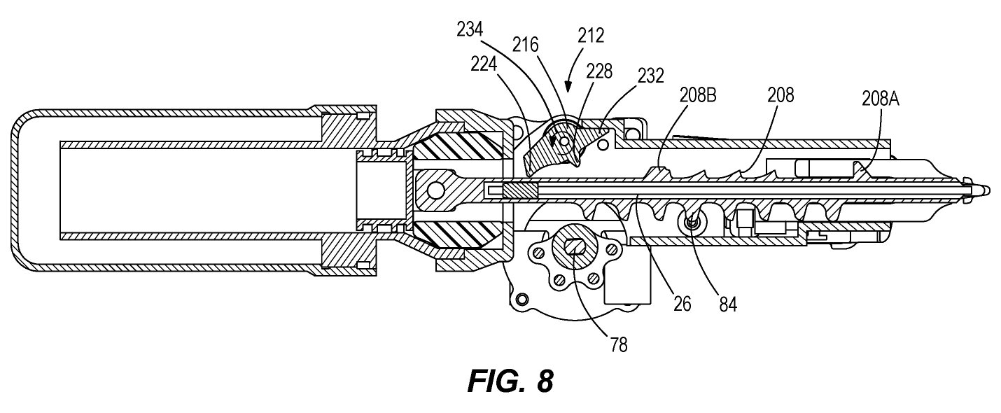

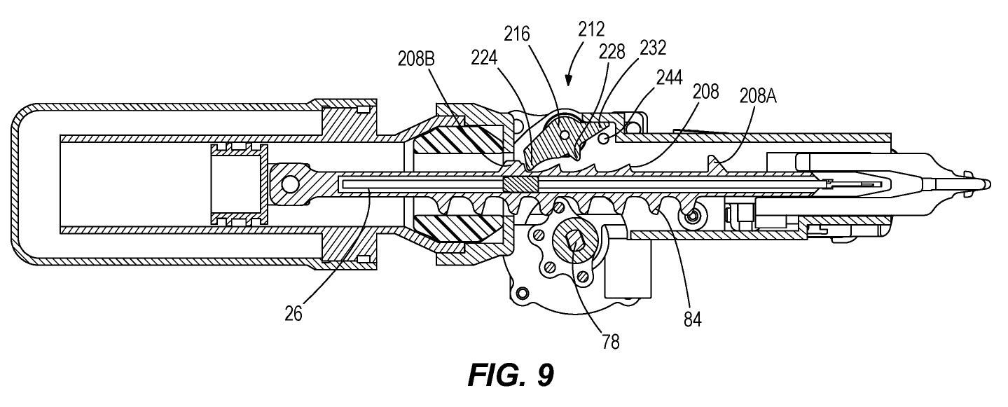

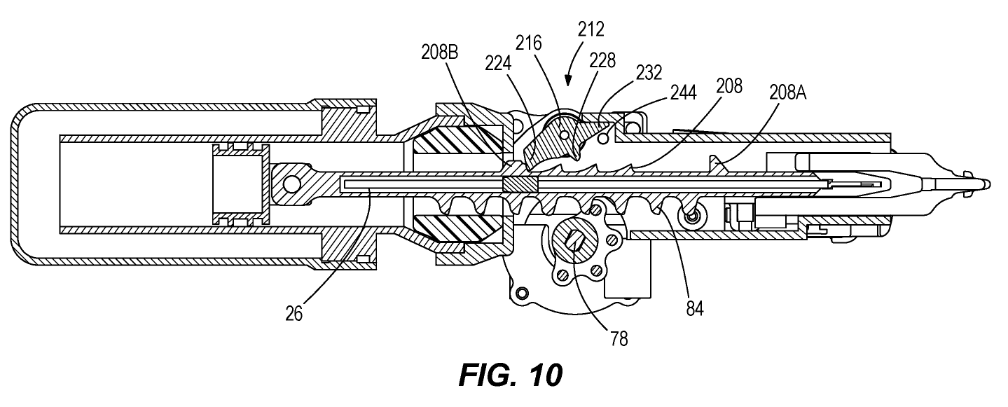

With reference to FIGS. 8-11, the driver 10 further includes a driver blade latch assembly 212 having a pawl or latch 216 for selectively holding the driver blade 26 in an intermediate position (FIG. 9) located between the BDC position and the ready position against a biasing force (i.e., the pressurized gas in the storage chamber 30). The intermediate position may be any position at which the driver blade 26 stops between the BDC position and the ready position. In the present embodiment, the number of lifter teeth 84 is greater than the number of drive pins 82; therefore, the lifter 78 requires more than one full rotation to move the driver blade 26 from the BDC position toward the TDC position. The intermediate position may also be the position at which the lifter 78 has completed one full rotation and the drive pins 82 are disengaged from the lifter teeth 84, with the latch 216 engaged with the latch tooth 208B as shown in FIG. 9. The latch assembly 212 is moveable between a latched state in which the driver blade 26 is held in the intermediate position (e.g., for clearing a jam, etc.), and a released state (FIG. 10) in which the driver blade 26 is permitted to be driven by the biasing force toward the driven position.

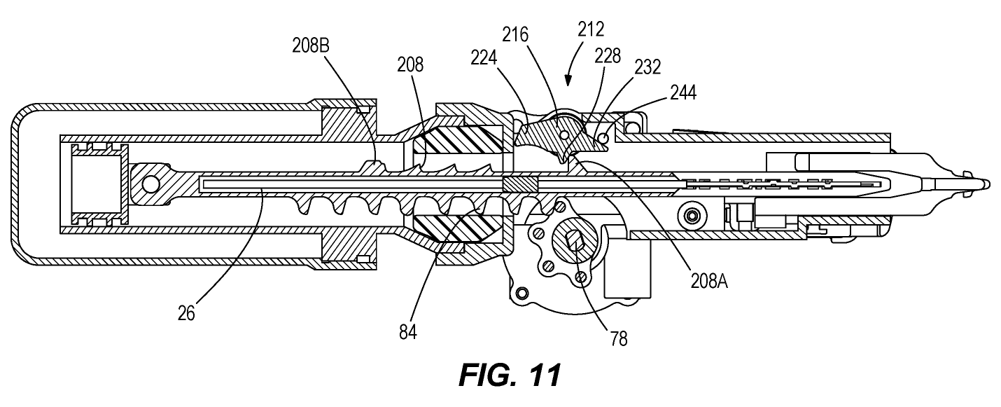

With reference to FIG. 6, the latch 216 is movably supported in the nosepiece 102. More specifically, the latch 216 is rotatable about a pivot axis 220 defined by a shaft 248 (FIG. 11) of the latch assembly 212. The pivot axis 220 is oriented parallel with the rotational axis 100 of the lifter 78. With reference to FIG. 8, the latch 216 includes a first finger 224, a second finger 228, and a third finger 232 extending therefrom, as further discussed below.

The latch 216 is moveable between a latched position (FIG. 9), coinciding with the latched state of the latch assembly 212, in which the latch 216 is engaged with one of the latch teeth 208 on the driver blade 26 for holding the driver blade 26 in the intermediate position, and a released position (FIG. 11), coinciding with the released state of the latch assembly 212, in which the latch 216 permits the driver blade 26 to be driven by the gas spring toward the driven position. In some embodiments, a biasing member, such as a torsional spring 234, biases the latch 216 toward the latched position and biases the first finger 224 toward engagement with the latch teeth 208.

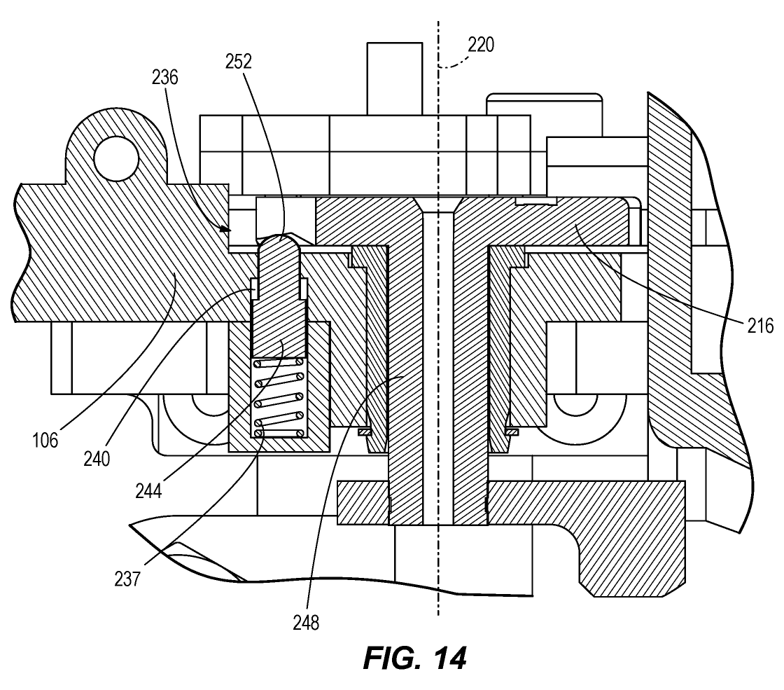

With reference to FIGS. 11 and 14, a detent mechanism 236 maintains the latch 216 in the released position. The detent mechanism 236 is supported within the nosepiece base 106 and includes a pin 244 having a spherical head 252 received within a bore 240 in the nosepiece base 106. The detent mechanism 236 also includes a spring 237 biasing the pin 244 outward from the bore 240 where the spherical head 252 can be engaged by the latch 216.

When in the latched position, the first finger 224 is configured to engage with the latch teeth 208. The driver blade 26 is at the BDC position (FIG. 8) and as it moves toward the TDC position, the first finger 224 engages each of the latch teeth 208, starting with the second latch tooth 208B. At this point only the first finger 224 is capable of engaging with the latch teeth 208. The drive pins 82 engage with the lifter teeth 84 and move the driver blade 26 towards the TDC position by an equivalent distance of four of the lifter teeth 84 (FIG. 9). At this point in the drive cycle, the first finger 224 of the latch 216 is engaged with the second latch tooth 208B to maintain the driver blade 26 in an intermediate position for a dwell time, during which none of the drive pins 82 are engaged with the lifter teeth 84. The lifter 78 continues to rotate and the drive pins 82 sequentially engage the lowermost four lifter teeth 84 (FIGS. 10-11) to move the driver blade 26 towards the TDC position. When the driver blade 26 reaches the ready position, which is slightly below the TDC position, the second finger 228 is engaged by the first latch tooth 208A, pivoting the latch 216 to the released position (FIG. 11). As the latch 216 moves to the released position, the third finger 232 moves over the spherical head 252 of the pin 244, pushing the pin 244 into the bore 240. When the finger 232 uncovers the pin 244, the pin 244 rebounds to an extended position and holds the latch 216 in the released position against the biasing moment applied by the torsion spring. The latch 216 is thereafter held in the released position, with the driver blade 26 in the ready position and the rotary lifter 78 stopped in the orientation shown in FIG. 11, prior to a subsequent fastener driving cycle being initiated.

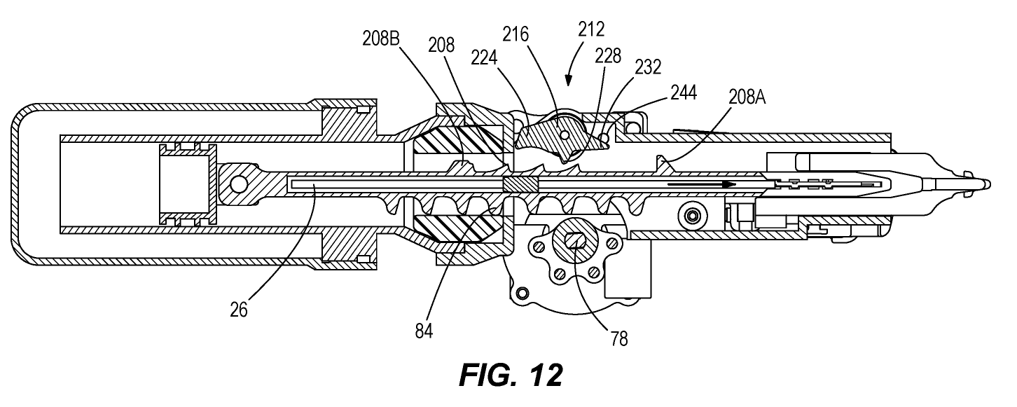

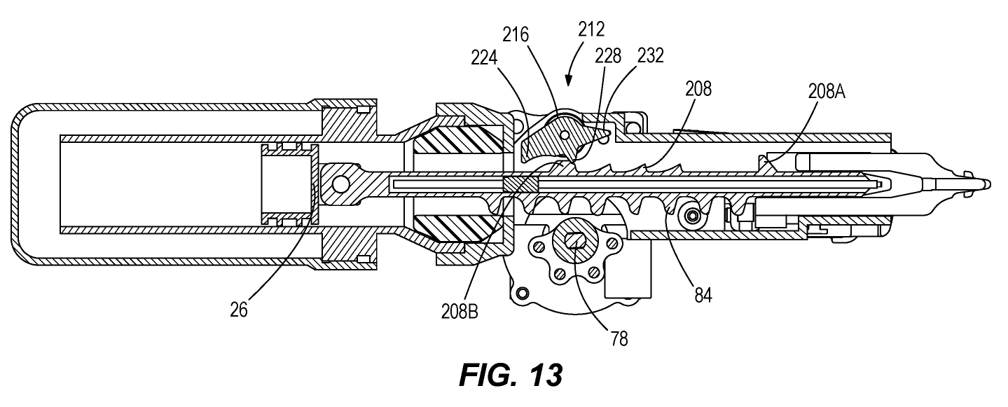

Upon firing of the fastener driver 10, the motor 50 is activated to rotate the rotary lifter 78 further in a counter-clockwise direction from the frame of reference of FIG. 11, causing the last drive pin 82 on the rotary lifter 78 to slip off the lowermost lifter tooth 84. Thereafter, with the rotary lifter 78 and the latch 216 disengaged from the driver blade 26, the driver blade 26 is accelerated towards the BDC position. As the driver blade 26 moves towards the BDC position, the second finger 228 on the latch 216 is engaged by the second latch tooth 208B, causing the latch 216 to pivot in a counter-clockwise direction from the frame of reference of FIGS. 12 and 13 to return the latch 216 to the latched position where it can engage the latch teeth 208 upon return of the driver blade 26 toward the TDC position. During pivoting movement of the latch 216 into the release position, the third finger 232 slides over the pin 244, which again retracts into the bore 240 until being uncovered again by the third finger 232, at which time the pin 244 is returned to its biased extended position for the subsequent fastener driving cycle.

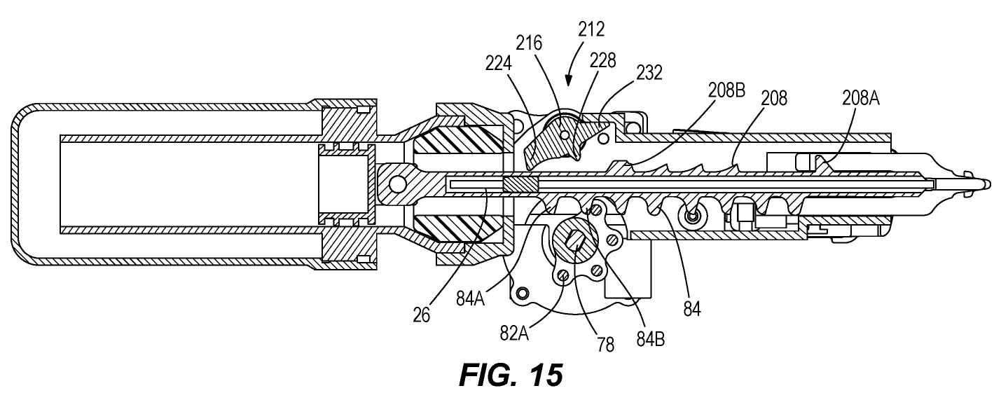

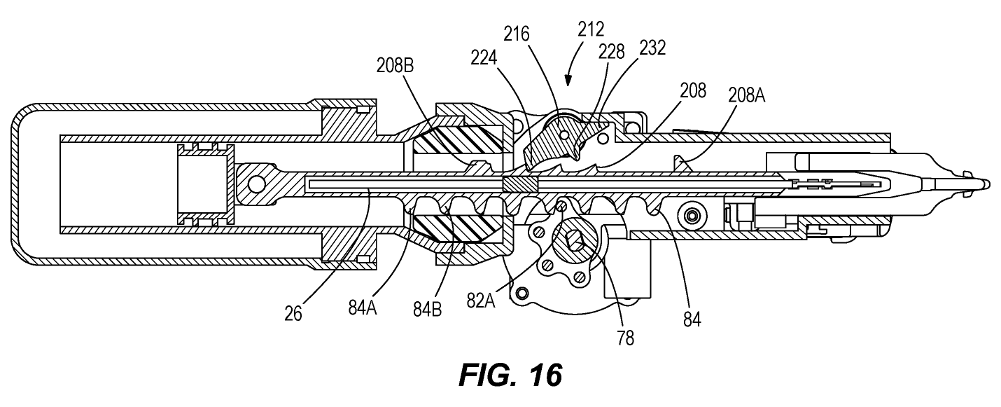

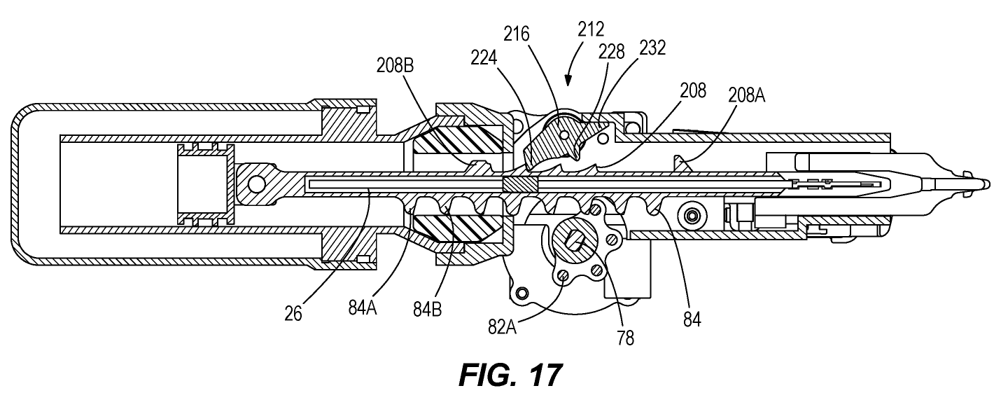

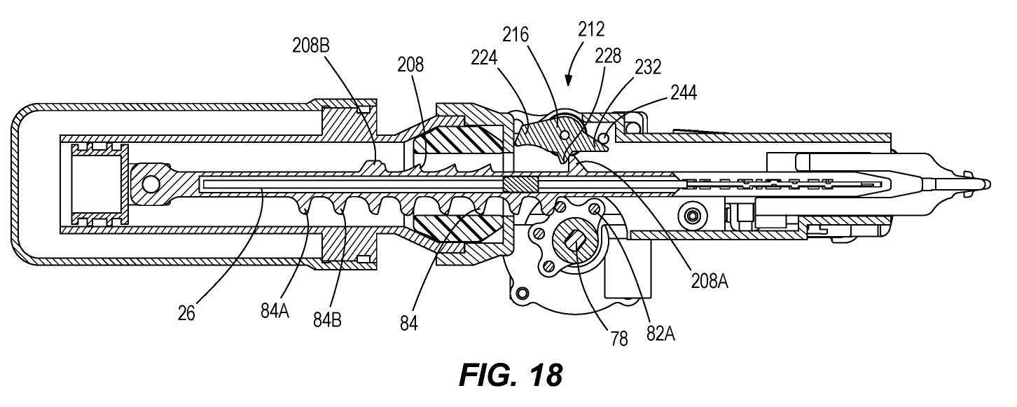

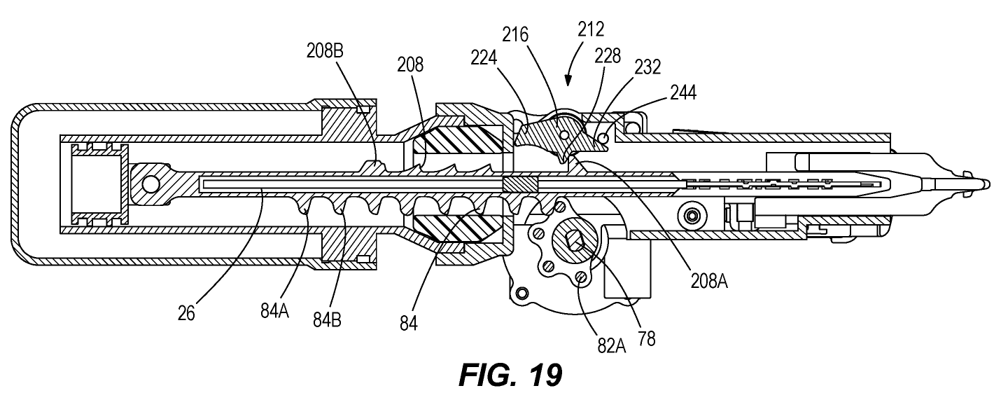

With reference to FIGS. 15-19, in the event of a jam scenario, the driver blade 26 and the lifter 78 can fall out of sync such that the drive pins 82 are not engaged on the expected lifter teeth 84 as they would be during normal operation. For example, the driver blade is at the BDC position and the drive pins 82 first engage with a second lifter tooth 84B instead of a first lifter tooth 84A (FIG. 15). As the driver blade 26 is moved towards the TDC position, the first finger 224 engages with the latch teeth 208 as it would during normal operation. Once the lifter 78 has completed one full rotation and enters the dwell time, the first finger 224 is engaged with the latch teeth 208 and holds the driver blade 26 in the intermediate position as the lifter 78 rotates until the drive pins 82 come back into engagement with the lifter teeth 84. The lifter teeth 84 engage with the drive pins 82, and the driver blade 26 is moved towards the TDC position. Once the driver blade 26 is at the ready position, the second finger 228 engages with the first latch tooth 208A, and the latch 216 is moved to the released position. As the latch 216 moves to the released position, the third finger 232 moves over the pin 244, which now holds the latch 216 in the released position. With reference to FIG. 18, the lifter 78 has one more of the drive pins 82 to rotate to bring the drive pins 82 back into sync with the lifter teeth 84. The lifter 78 continues to rotate and the driver blade 26 slips onto a last driver pin 82A to bring the driver blade 26 and lifter 78 back into sync.

Although the disclosure has been described in detail with reference to certain preferred embodiments, variations and modifications exist within the scope and spirit of one or more independent aspects of the disclosure as described.

Various features of the invention are set forth in the following claims.

What is claimed is:

1. A powered fastener driver comprising:
a housing;
a cylinder within the housing;
a piston movable within the cylinder from a top-dead-center (TDC) position to a driven or bottom-dead-center (BDC) position;
a driver blade attached to the piston for movement therewith along a driving axis from the TDC position toward the BDC position for driving a fastener into a workpiece, the driver blade including
a first longitudinal side having a plurality of lifter teeth, and
a second longitudinal side having a plurality of latch teeth;
a lifter operable to engage the plurality of lifter teeth and move the piston and driver blade from the BDC position toward the TDC position;
a drive unit operably coupled to the lifter to provide torque thereto, causing the lifter to rotate; and
a latch movable between a released position in which the latch is incapable of contacting any of the latch teeth, and a latched position in which the latch directly contacts the latch teeth to prevent movement of the driver blade from the TDC position toward the BDC position,
wherein the latch is moved from the latched position to the released position in response to direct contact with a first latch tooth of the plurality of latch teeth during movement of the driver blade toward the TDC position, and
wherein the latch is moved from the released position to the latched position in response to direct contact with a second latch tooth of the plurality of latch teeth during movement of the driver blade toward the BDC position.

2. The powered fastener driver of claim 1, wherein, with the latch in the latched position, the latch includes a first finger configured to engage each of the latch teeth on the driver blade except the first latch tooth.

3. The powered fastener driver of claim 2, wherein the latch includes a second finger configured to engage the first latch tooth during movement from the latched position to the released position.

4. The powered fastener driver of claim 3, further comprising a detent mechanism configured to hold the latch in the released position during movement of the driver blade from the TDC position toward the BDC position, wherein the latch is moved from the released position to the latched position in response to an impact between the second latch tooth and the second finger, overriding the detent mechanism, before the driver blade reaches the BDC position.

5. The powered fastener driver of claim 4, wherein the latch includes a third finger configured to engage the detent mechanism and hold the latch in the released position.

6. The powered fastener driver of claim 4, wherein the detent mechanism includes:
a pin configured to engage and maintain the latch in the released position after the latch is moved to the released position, and
a spring biasing the pin outward from a bore in which the pin is received to a position where the pin is engageable by the latch.

7. The powered fastener driver of claim 1, wherein the latch is pivotable between the latched position and the released position.

8. The powered fastener driver of claim 1, wherein the driver blade includes a tip at a first end of the driver blade configured to contact a fastener during a fastener driving operation, wherein the piston is coupled to an opposite, second end of the driver blade, and wherein the first latch tooth is the one of the plurality of latch teeth closest to the tip.

9. The powered fastener driver of claim 8, wherein the second latch tooth is the one of the plurality of latch teeth closest to the second end of the driver blade.

10. The powered fastener driver of claim 1, wherein the plurality of latch teeth between the first latch tooth and the second latch tooth have a uniform shape.

11. A powered fastener driver comprising:
a cylinder;
a piston movable within the cylinder from a top-dead-center (TDC) position to a driven or bottom-dead-center (BDC) position;
a driver blade attached to the piston for movement therewith along a driving axis from the TDC position toward the BDC position for driving a fastener into a workpiece, the driver blade including
a plurality of lifter teeth, and
a plurality of latch teeth separate from the lifter teeth;
a lifter operable to engage the plurality of lifter teeth and move the piston and driver blade from the BDC position toward the TDC position;
a latch pivotable between a released position in which the latch is incapable of contacting any of the latch teeth, and a latched position in which the latch directly contacts the latch teeth to prevent movement of the driver blade from the TDC position toward the BDC position; and
a detent mechanism including
a pin configured to engage and maintain the latch in the released position after the latch is pivoted to the released position, and
a spring biasing the pin outward from a bore in which the pin is received to a position where the pin is engageable by the latch,
wherein the pin maintains the latch in the released position until overridden by contact with the driver blade to return the latch to the latched position.

12. The powered fastener driver of claim 11, wherein the latch includes a finger configured to slide over the pin during movement of the latch between the released position and the latched position.

13. The powered fastener driver of claim 11, wherein the pin includes a spherical head configured to engage a mating surface on the latch.

14. The powered fastener driver of claim 11, wherein movement of the piston and the driver blade toward the BDC position causes one of the plurality of latch teeth to engage the latch, thereby overriding the detent mechanism and returning the latch to the latched position.

15. A latch system for selectively retaining a driver blade in a powered fastener driver, the latch system comprising:
a latch movable between a latched position and a released position;
a plurality of latch teeth on the driver blade, including at least a first latch tooth and a second latch tooth spaced along a longitudinal side of the driver blade;
a first finger on the latch configured to engage one of the plurality latch teeth to hold the driver blade in an intermediate position between a bottom‑dead‑center (BDC) position and a top‑dead‑center (TDC) position;
a second finger on the latch configured to be contacted by the first latch tooth during movement of the driver blade toward the TDC position to move the latch from the latched position to the released position; and
a detent mechanism configured to maintain the latch in the released position until overridden by movement of the driver blade toward the BDC position.

16. The latch system of claim 15, wherein the second latch tooth contacts the second finger to return the latch from the released position to the latched position, overriding the detent mechanism, in response to movement of the driver blade toward the BDC position.

17. The latch system of claim 15, wherein the latch further includes a third finger configured to contact the detent mechanism when the latch moves into the released position, and wherein the third finger overcomes a force of a biasing member of the detent mechanism in response to the latch transitioning from the latched position to the released position.

18. The latch system of claim 15, wherein the latch is pivotable between the latched position and the released position.

19. The latch system of claim 15, wherein the first finger is configured to engage the second latch tooth located closer to a piston‑coupled end of the driver blade than the first latch tooth, thereby maintaining the driver blade in the intermediate position.

20. The latch system of claim 15, further comprising a biasing member configured to bias the latch toward the latched position such that the first finger is biased into engagement with the latch teeth during movement of the driver blade toward the TDC position.
